(19) United States
(12) Patent Application Publication
(10) Pub. No.: US 2018/0153025 A1
(43) Pub. Date: May 31, 2018

(54) LIGHT BULB HAVING TIMING CAPABILITY

(71) Applicant: Shang-Jie Lin, Taipei City (TW)

(72) Inventor: Shang-Jie Lin, Taipei City (TW)

(21) Appl. No.: 15/362,835

(22) Filed: Nov. 29, 2016

(51) Int. Cl. H05B 37/02; F21V 3/04; F21V 23/00; F21V 23/04

(52) U.S. Cl. CPC H05B 37/0281; F21V 23/0407; F21V 23/002; F21V 3/0418

(57) ABSTRACT

The light bulb includes an enclosure, a base, a column, a pair of conductive wires, a lighting element, and a control module. The enclosure is vacuum inside. The column has a bottom end fixedly joined to the base, and extends upward into the enclosure. The control module is at a top end of the column with an IC element inside. Each conductive wire has a first end electrically connected to circuit elements inside the base. The conductive wires run through the column, and then run out of the top end of the column and have their second ends joined to two ends of the lighting element, respectively. The lighting element is one of a LED, a filament, and a CCFL element. The control module controls at which specific times to turn on/off and to flash the lighting element through the IC inside the control module.

### BACKGROUND OF THE INVENTION

### (a) Technical Field of the Invention

The present invention is generally light source, and more particular to a light bulb having built-in timing capability.

### (b) Description of the Prior Art

To automatically turning on/off and flashing an existing light bulb at specific times, usually an external timing controller is employed. This is not only more costly but also less convenient. It would be an ideal light device if the light bulb itself has built-in timing capability to turn on/off and flash the light bulb at specific times automatically.

### SUMMARY OF THE INVENTION

Therefore a light bulb with built-in timing capability is disclosed herein so that the light bulb may be turned on/off and flashed at specific times without employing some external timer.

The light bulb includes an enclosure, a base, a column, a pair of conductive wires, a lighting element, and a control module. The enclosure is vacuum inside and tightly joined to the base. The column has a bottom end fixedly joined to the base, and extends upward into the enclosure. The control module is at a top end of the column with an IC element inside. Each conductive wire has a first end electrically connected to circuit elements inside the base. The conductive wires run through the column, and then run out of the top end of the column and have their second ends joined to two ends of the lighting element, respectively. The control module controls at which specific times within 24 hours to turn on/off and to flash the lighting element through the IC inside the control module.

The enclosure is made of glass and the lighting element may be a light emitting diode (LED), a filament, or a cold cathode fluorescent lamp (CCFL) element.

The light bulb is operable with AC power between 100 and 240V and frequency between 50 and 60 Hz.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective schematic diagram showing a light bulb having timing capability according to an embodiment of the present invention.

FIG. 2 is a perspective schematic diagram showing a light bulb having timing capability according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

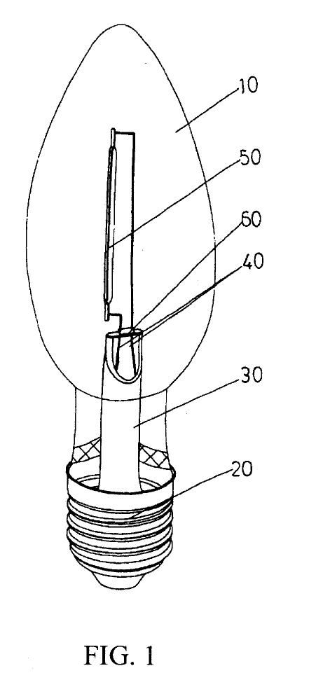

As illustrated in FIG. 1, a light bulb having timing capability according to an embodiment of the present invention includes an enclosure 10, a base 20, a column 30, a pair of conductive wires 40, a lighting element 50, and a control module 60. The enclosure 10 is made of glass, and has a bottom end closely joined to an open top end of the base 20. The inside of the enclosure 10 is in a vacuum and airtight state. Inside the base 20, there are a number of required circuit elements, which should be familiar to those having ordinary skill in the related art and their details are omitted here. The open top end of the base 20 is tightly joined to the bottom end of the enclosure 10. The column 30 has a bottom end fixedly joined to the inside of the base 20, and extends upward into the inside of the enclosure 10. The conductive wires 40 run along the column 30, and each conductive wire 40 has a first end electrically connected to the circuit elements inside the base 20. The control module 60 is configured at a top end of the column 30 inside the enclosure 10. An integrated circuit (IC) element is configured inside the control module 60 for flashing the lighting element 50. There are also circuit arrangement inside the control module 60 for turning on and off the lighting element 50 at specific times. As the conductive wires 40 extend upward, they first run through the column 30 and electrically connected to the control module 60, and then run out of the top end of the column 30 and have their second ends joined to two ends of the lighting element 50, respectively, which may be a light emitting diode (LED), a filament, or a cold cathode fluorescent lamp (CCFL) element. The control module 60 controls at which specific times within 24 hours to turn on or off and whether to flash the lighting element 50.

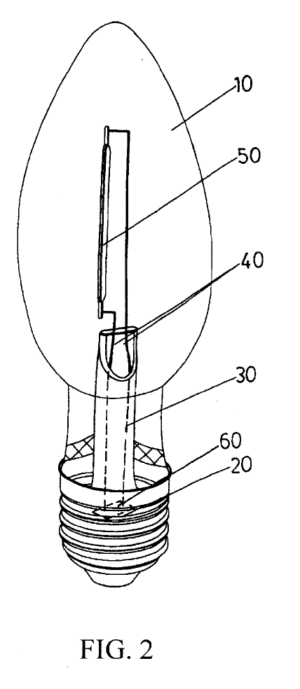

FIG. 2 depicts a second embodiment of the light bulb where the control module 60 is configured inside the base 20 and electrically connected to the conductive wires 40 there, instead of being located at the top end of the column 30.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A light bulb having timing capability, comprising an enclosure, a base, a column, a pair of conductive wires, a lighting element, and a control module, wherein the enclosure has a bottom end closely joined to an open top end of the base; required circuit elements are configured inside the base; the column has an elongated and linear shape; the column has a bottom end fixedly joined to the inside of the base; a top portion of the column extends vertically upward into the inside of the enclosure; each conductive wire has a first end electrically connected to the circuit elements inside the base; the control module is configured at a top end of the column inside the enclosure and electrically connected to the conductive wires; an integrated circuit (IC) element is configured inside the control module for flashing the lighting element; there are also circuit elements inside the control module for turning on and off the lighting element at specific times; as the conductive wires extend upward, they first run through the column, and then out of the top end of the column and have their second ends joined to two ends of the lighting element, respectively; and the control module controls at which specific times within 24 hours to turn on or off and whether to flash the lighting element.

2. (canceled)
